(19) United States
(12) Patent Application Publication
(10) Pub. No.: US 2016/0066515 A1
(43) Pub. Date: Mar. 10, 2016

(54) Secure and Externally Controllable Growing Enclosure

(71) Applicant: Podgrow, LLC, Bridgeport, CT (US)

(72) Inventor: Joseph A. Palmieri, Jr., Bridgeport, CT (US)

(73) Assignee: Podgrow, LLC, Bridgeport, CT (US)

(21) Appl. No.: 14/481,756

(22) Filed: Sep. 9, 2014

(51) Int. Cl. A01G 9/14; A01G 1/00; A01G 9/20; A01G 9/24; A01G 27/00

(52) U.S. Cl. CPC A01G 9/14; A01G 9/241; A01G 27/003; A01G 9/20; A01G 1/001

(57) ABSTRACT

A system for growing controlled plants, including a securable enclosure having a lighting system, an environmental control system and an irrigation system. A control unit that is positioned outside of the enclosure is configured to control the lighting, environmental control, and irrigation systems to facilitate a grow cycle.

### FIELD OF THE DISCLOSURE

The subject matter of the present disclosure generally relates to growing plants of a controlled nature, and more particularly relates to a secure, externally controlled growing enclosure.

### BACKGROUND OF THE DISCLOSURE

The growing of medicinal and other controlled plants presents certain challenges. Many of these challenges are particularly acute in the growing of commercial-grade marijuana for markets allowing medical or recreational use of marijuana and marijuana-derived products. While the growing of marijuana outside and in custom grow houses has been widely known, commercialized markets present hazards not previously encountered. For the purposes of the present disclosure, controlled plants should be understood to refer broadly to plants subject to government regulation or other specialized control, regardless of the exact nature, efficacy or utility of the resultant plant or plant-product. Often, controlled plants have a higher monetary value per unit weight than produce and many other plants, which creates a unique set of challenging conditions.

Many jurisdictions allowing for commercial production of marijuana have in place onerous regulatory schemes with myriad requirements that producers must adhere to gain and/or retain proper licensing. These regulatory schemes often include such things as stringent quality control standards. Also, many regulatory schemes, and business plans from a safety and profitability standpoint, require significant security measures to prevent unauthorized access to marijuana plants. For many commercial operations compliance with such regulations can be a significant and sometimes insurmountable financial and technical burden.

Maintaining proper growing conditions while growing such plants can present certain difficulties. If environmental conditions such as air quality and humidity are not properly controlled, plant yield and quality can suffer significantly. Even temporary lapses in environment quality can negatively impact grow cycles. In stringently regulated markets, quality problems may render certain operations unviable. For instance, many marijuana growing operations suffer from unacceptable levels of pathogens such as black mold, brown rot, grey mold, penicillium mold, rhizopus rot, colletotrichum rot, snow mold and mucor mold. Destructive organisms such as insects also pose a significant threat to growing operations.

The trend towards greater social acceptance of marijuana and the accompanying trend of marijuana decriminalization only make more pressing and substantial the problems outlined above.

The subject matter of the present disclosure is directed to overcoming, or at least reducing the effects of, one or more of the problems set forth above.

### BRIEF SUMMARY OF THE DISCLOSURE

Disclosed is a system for and method of operating a grow enclosure for controlled plants. In an exemplary embodiment, an enclosure is used to secure a number of plants during a grow cycle. Lighting, environmental control and irrigation systems aid in maintaining environment conditions that can facilitate an expedient and efficient growth cycle. These systems are operated outside of the enclosure by an external control unit, thereby reducing or eliminating the need for access to the plants by persons during the grow cycle.

Units may be colloquially referred to as ‘grow pods.’ The disclosed grow pods have several advantages over existing systems. Security is provided for the plants and more easily maintained by operation of the system from the exterior of a secured enclosure. Environmental conditions can be consistently maintained to prevent the types of mold growth prevalent in other growing operations, and also prevent other contaminations from reducing product yield or quality. Furthermore, the presence of undesirable insects such as spider mites, Sciaridae flies, white flies, Vine weevil, Aphids, Thrips and Fungus gnats can be prevented. These aspects also allow growers to maintain a growing operation within strict regulatory parameters that may otherwise be exceeded.

### BRIEF DESCRIPTION OF THE DRAWINGS

The foregoing summary, preferred embodiments, and other aspects of the present disclosure will be best understood with reference to a detailed description of specific embodiments, which follows, when read in conjunction with the accompanying drawings, in which:

FIG. 1 is a perspective view of the exterior of an embodiment.

FIG. 2 is a cutaway perspective view of the interior of the embodiment of FIG. 1.

FIG. 3 is a bottom plan cutaway view of the interior of the embodiment of FIG. 1.

FIG. 4 is a top plan cutaway view of the interior of the embodiment of FIG. 1.

FIG. 5 is a side schematic diagram of the interior of an air filtration system.

FIG. 6 is a schematic diagram of a setup of remotely managed pods.

FIG. 7A is a perspective view of a preferred embodiment.

FIG. 7B is a cutaway perspective view of the interior of the preferred embodiment of FIG. 7A.

FIG. 7C is an interior perspective view of the preferred embodiment of FIG. 7A.

FIG. 8 is a perspective view of insulation panels configured to be seated in the walls of an enclosure.

Like reference numbers and designations in the various drawings indicate like elements.

### DETAILED DESCRIPTION

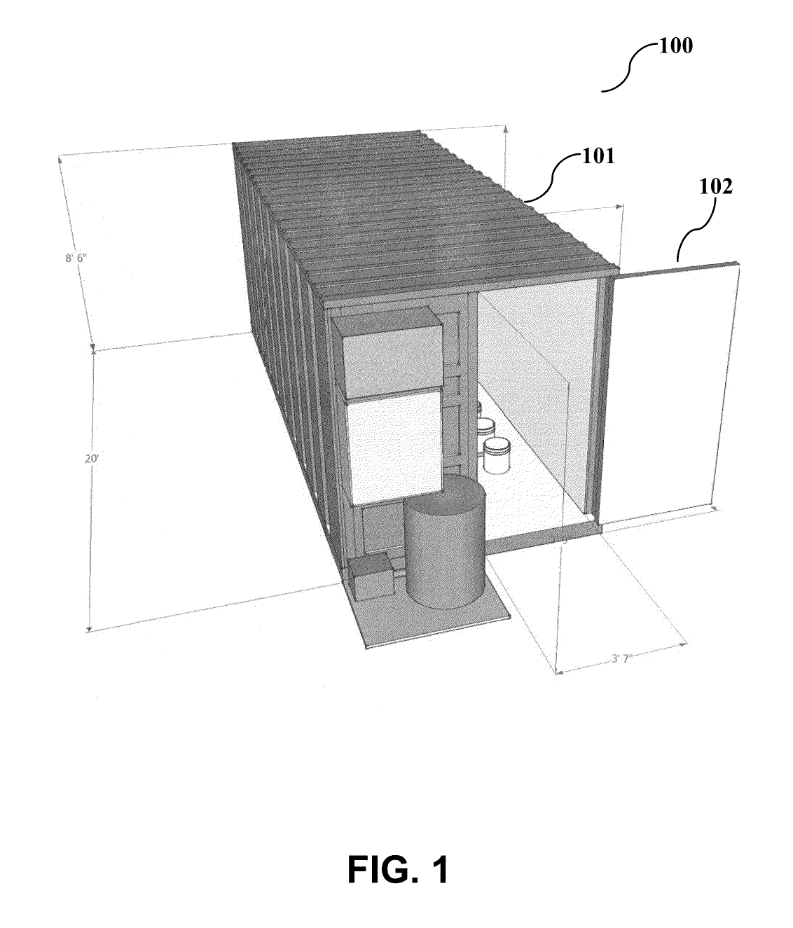

In reference to FIG. 1, an exemplary growing system is generally designated as 100. System 100 houses the plants to be grown and provides security and a means by which to environmentally control growing conditions. In the embodiment, securable door 102 provides a means of environmentally sealing enclosure 101 and also a means to control access to enclosure 101 to, for instance, prevent unauthorized individuals from obtaining plants contained in enclosure 101.

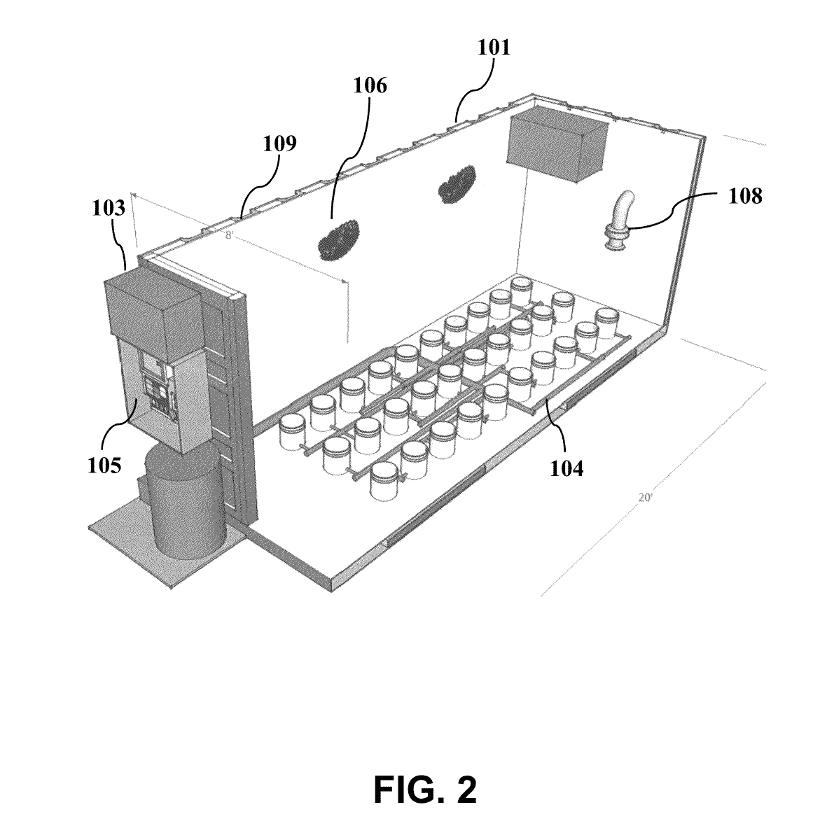

FIG. 2 depicts a cutaway view of system 101 showing some internal components of enclosure 101. Environmental control system 103 maintains environmental conditions in enclosure 101 that facilitate the growing of controlled plants (not shown) in enclosure 101. Irrigation system 104 provides those plants with hydration, which optionally may include suitable compositions such as fertilizer or nutrients needed by the plants. Control unit 105 is positioned outside of enclosure 101. Fans 106 provide circulation of the ambient air in enclosure 101. An air filtration system (not pictured) is provided as part of environmental control system 103, that takes air from the exterior of enclosure 101 and provides it to the interior of enclosure 101, preferably processing the air to facilitate plant growth, preventing contaminants from entering the enclosure and preventing adverse conditions from ever occurring during the entirety of the grow cycle. Air outlet 108 allows air to leave enclosure 101. When processed air is supplied by the air filtration system, a positive pressure may be maintained in enclosure 101, preventing unprocessed and/or unfiltered air from entering enclosure 101 through air outlet 108. Insulation paneling 109 installed within the walls of enclosure 101 allows for easier thermal management of environmental conditions within enclosure 101.

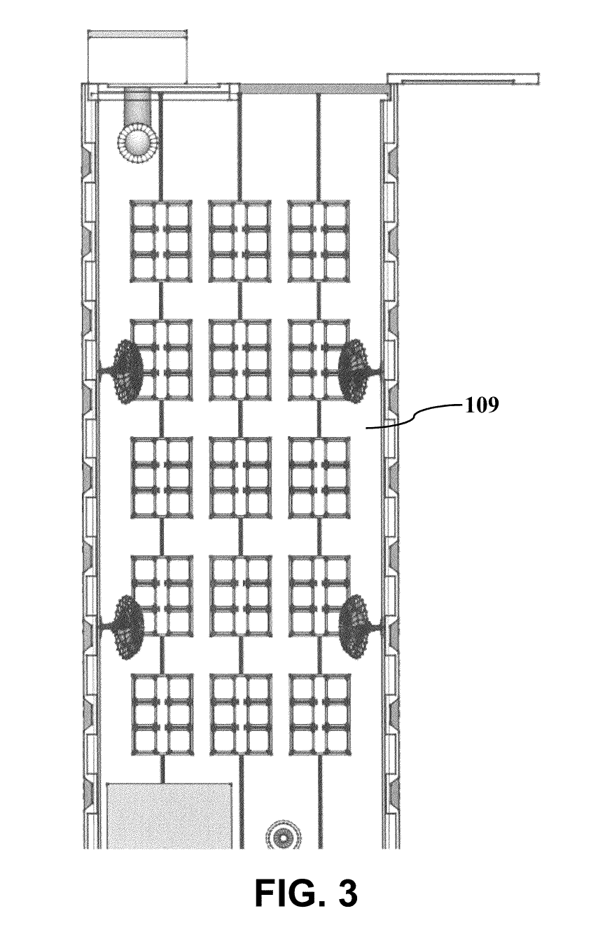

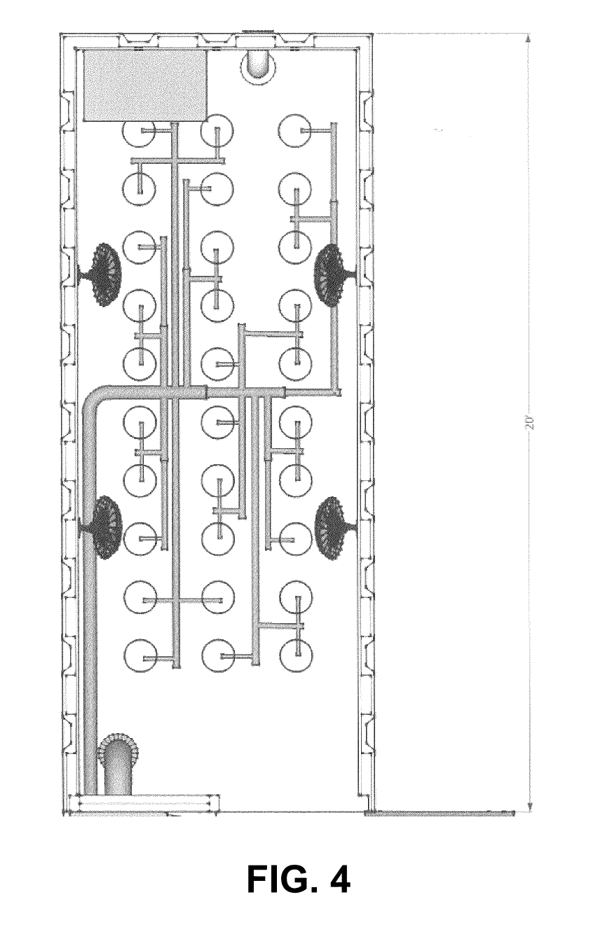

FIG. 3 depicts a bottom plan cutaway view of system 100. Lighting system 109 provides the light necessary to grow the enclosed plants. Control unit 105 controls the operation of lighting system 109, environmental control system 103 and irrigation system 104. FIG. 4 depicts a top plan cutaway view of system 100.

Environmental control systems may also include a humidity control unit or dehumidifier. An exemplary dehumidifier found to be effective is the 105 Dual Dehumidifier manufactured by QUEST of Madison, Wis. Control of humidity conditions can help deter or prevent the growth of destructive molds, Botrytis Cinerea and other bacteria.

In certain embodiments, modified shipping containers can be used as enclosures. Enclosures generally may take many sizes and shapes. Particular embodiments have been 20 and 40 feet in length, while being 8 feet wide and 7 feet, 9 inches tall. Insulated walls sandwiched by 2-20 gauge steel were found to generally provide adequate security. Joints in the enclosure may include a rubberized gasket seal between the ceiling and floor to ensure more effective encapsulation. Control units for use in embodiments may adhere to certain standards developed by parties other than the manufacturer or user, such as the NEMA 3R rating scheme.

Various lighting systems may be employed in embodiment systems. Preferably, a light emitting diode (LED) lighting system is employed. Such a system presents several advantages over alternative systems, including significant savings in power consumption that can add to the financial viability of a growing operation, and also reduce or eliminate the need to vent lighting-related heat from a growing enclosure. Alternatively, high pressure sodium lighting may be employed. In such a case, additional supporting hardware, such as a two stage filter for cooling the lighting, and power ballasts, may be employed. The control unit of an embodiment may allow adjustment of the height and spectrum of the lighting system.

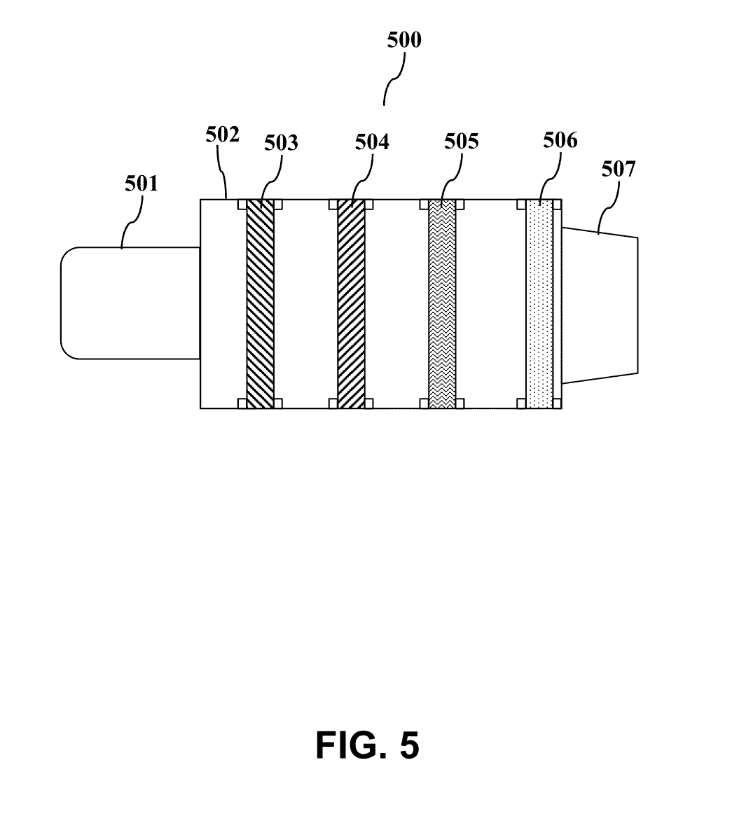

FIG. 5 depicts a cutaway schematic view of an exemplary air filtration system 500. Air inlet 501 is configured to receive air from the exterior environment. Air filter body 502 contains filter elements 503, 504, 505, and 506, which are configured to provide a three stage filter for enclosure 101. Preferably, each of the filter elements serves a different filtering function. Air duct 507 passes filtered air to enclosure 101. Those of skill in the art to which the present disclosure pertains will understand that airflow can be maintained through air filtration system 500 by any suitable means, such as a fan. In the embodiment, air filtration system 500 is effective to regulate various environmental contaminants, such as dust, mold, pollen, insects and chemical pollutants to facilitate the grow cycle. In a demonstrated embodiment, a filter unit contains a pre-filter, an antibacterial filter, a carbon zeolite filter and an activated carbon filter.

In a preferred embodiment, system 100 includes a security monitoring system. Such a system may optionally employ a wide number of security technologies that will be readily apparent to those of skill in the art to which the present disclosure pertains, including door locks and sensors, motion sensors, video cameras, etc. Preferably, the security system maintains a record of instances of entrance to and movement within the enclosure during a grow cycle. Thus, access to the plants within the enclosure may be strictly controlled, to prevent theft or other illicit activity. Functionality may include forbidding off-hour access. The positioning of the control unit outside of the secured enclosure provides the significant benefit that little if any physical activity by persons is necessary within the enclosure during a grow cycle. All aspects of the grow cycle can be controlled from the enclosure's exterior, significantly reducing the chance of improper employee conduct. In certain embodiments, the security system may be remotely monitored, for instance via a mobile device such as a cell phone, so that physical proximity to the growing enclosure is not required. Thus, management or security staff may concentrate on other tasks. In addition to security functions, cameras placed inside the enclosure may facilitate growers in operating the system. Preferably, environmental conditions are controlled so as to hold ideal conditions on a continuous basis throughout the entirety of the grow cycle, so that the plants are never stressed, thereby preventing slowed or interrupted growth. When carbon dioxide is employed, conditions can be maintained to prevent carbon dioxide loss from the enclosure.

Another advantage of the disclosed system is that its configuration is particularly suitable for rapid scaling of operations. In certain demonstrated embodiments, the enclosure can be transported without substantial disassembly, for instance, without removing certain components of the system, such as the irrigation or lighting systems. Thus, pods may be moved to a growing location and rapidly deployed, in certain instances in a matter of minutes. Operations can therefore be rapidly scaled and to begin producing product nearly immediately.

In operation, a grower or growers plant seeds or seedlings in the securable enclosure. This may entail placing plants into individual potting units, that may be irrigated, or in groups on tables, among other possible configurations that will be readily apparent. The enclosure is then secured, for instance, by closing and locking an entrance door. The grow cycle is then undertaken, during which the external control unit facilitates plant growth by operating the irrigation, lighting, and environmental control systems. Continuous maintenance of optimum environmental conditions over the course of a grow cycle promotes plant yield and quality. Thus, because the disclosed system accomplishes continuous and, in some embodiments, totally autonomous control over environmental conditions, optimized yields and quantities are made possible.

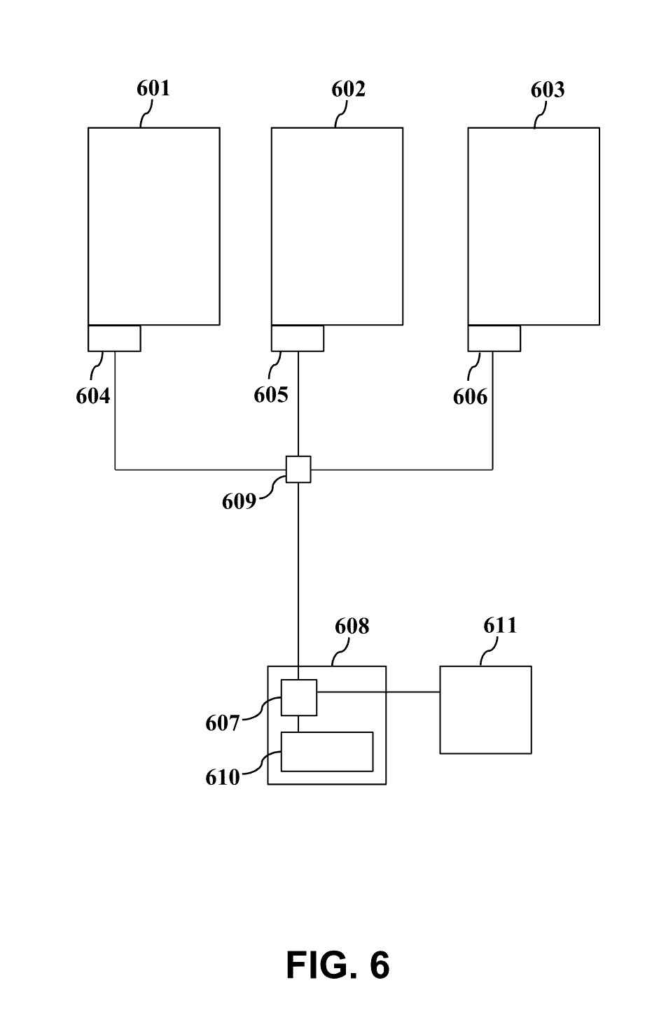

FIG. 6 depicts a schematic diagram of an exemplary setup of multiple pods. Pods 601, 602 and 603 each have a respective control unit, here 604, 605 and 606. Control units 604, 605 and 606 each communicate with processor 607 of computer 608 through intermediary node 609, that could be, for instance, an Internet router. Alternatively, control units 604, 605 and 606 could communicate directly with computer 608. Processor of 607 can cause to be encoded on digital storage medium 610 information regarding the operation of pods 601, 602 and 603. For instance, access information about the pods could be recorded to provide a security log of individuals accessing the pods. Digital storage medium 610 may be any suitable medium, such as a disk hard drive or solid state hard drive. In the embodiment, processor 607 causes to be presented on display 611 information about the operation of the pods. In the embodiment, computer 608 and display 611 are remote from pods 601, 602 and 603, so that a user can operate and manage the pods from a remote location. Any desired number of pods or configurations could be employed as desired or needed. For instance, pods could be stacked or aligned in rows.

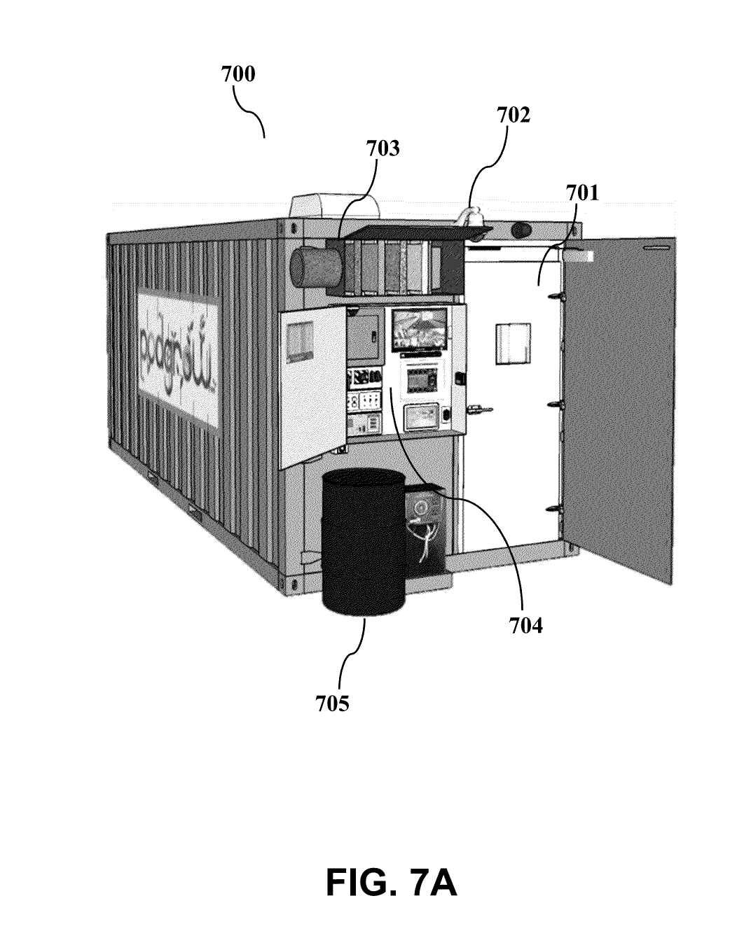

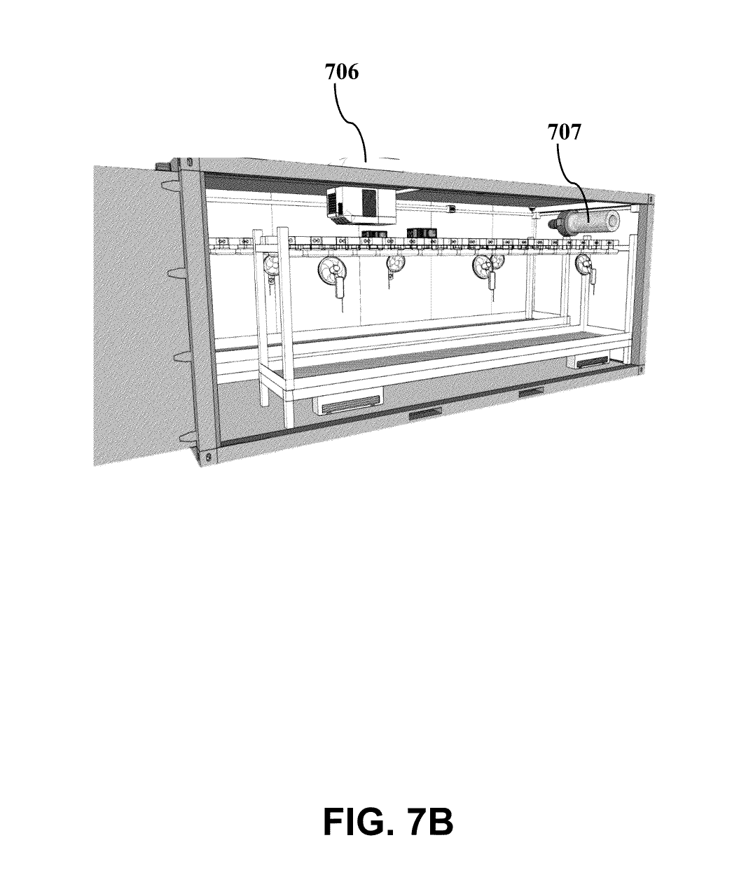

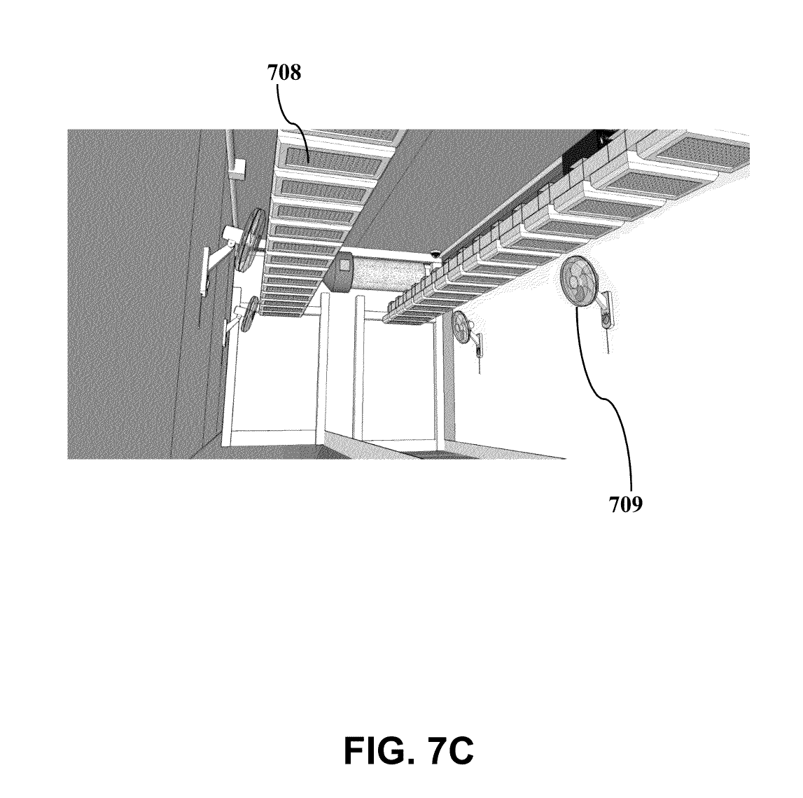

FIG. 7A depicts a perspective view of a preferred grow pod 700. Securable door 701 provides a security and environmental barrier between the outside and the interior of grow pod 700. Camera 702 monitors access to grow pod 700, and in the embodiment, video analysis of the view of camera 702 can be automatically processed to, for instance, report when motion is detected in vicinity to grow pod 700. Air filtration system 703 (shown open), filters air that is then fed to the enclosure of grow pod 700. Control unit 704 allows a user to oversee and facilitate a grow cycle by, among other things, viewing the feeds of various cameras and adjusting environmental parameters. Irrigation tank 705 holds water or other sustaining fluids for delivery to the plants inside the enclosure at specified rates and times.

FIG. 7B depicts a cutaway perspective view of grow pod 700, in which a side wall of grow pod 700 is not depicted. Humidity control system 706 adjusts the humidity of the air in the enclosure of grow pod 700 to help maintain optimal growing conditions. Air outlet 707 allows air to exit the enclosure of grow pod 700.

FIG. 7C depicts the interior of grow pod 700, from the perspective of a growing tray within the enclosure. LED lighting system 708 provides the light required by the plants being grown (not shown). Fans 709 provide air circulation in grow pod 700.

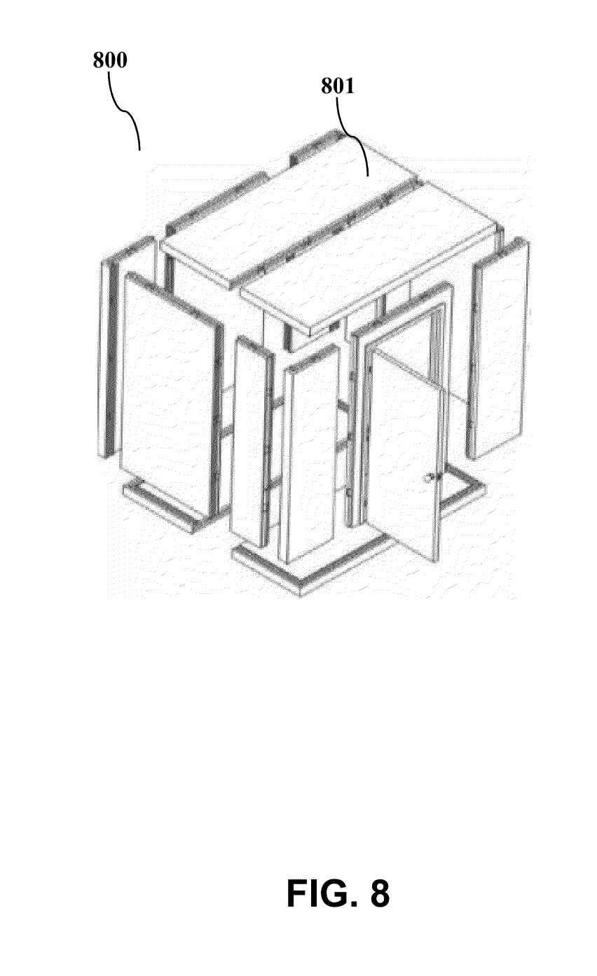

FIG. 8 depicts insulation system 800 that includes a number of insulation panels 801. Insulation panels 801 may optionally be installed in the walls of an enclosure to assist in the thermal regulation of growing conditions within the enclosure.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed is:

1. A system for growing controlled plants, comprising:
a securable enclosure;
said enclosure having a lighting system, an environmental control system, and an irrigation system; and
a control unit positioned outside of the enclosure and configured to control the lighting system, environmental control system and the irrigation system to facilitate a grow cycle.

2. The system of claim 1, wherein the environmental control system includes an air filtration system.

3. The system of claim 2, wherein the air filtration system utilizes at least one three stage filter.

4. The system of claim 3, wherein the air filtration system is effective to regulate at least one of dust, mold, pollen, insects and chemical pollutants to facilitate the grow cycle.

5. The system of claim 4, wherein the air filtration system is a single stage air filtration system and the lighting system is a light emitting diode (LED) lighting system.

6. The system of claim 4, wherein the air filtration system is a two stage air filtration system and the lighting system is a high pressure sodium (HPS) lighting system.

7. The system of claim 1, wherein the environmental control system includes a humidity control system effective to regulate a humidity level in the enclosure.

8. The system of claim 1, further comprising a security monitoring system.

9. The system of claim 8, wherein the security monitoring system maintains a record of instances of entrance to and movement within the enclosure during the grow cycle.

10. The system of claim 1, wherein the operation of the control unit can be remotely monitored and controlled.

11. The system of claim 1, wherein the enclosure and control unit are configured to be readily relocatable without substantial disassembly.

12. A method for growing a plurality of controlled plants, comprising:
providing a securable enclosure;
said enclosure having a lighting system, an environmental control system, and an irrigation system;
providing a control unit positioned outside of the enclosure;
positioning one of a plurality of plant seeds or a plurality of plant seedlings inside the enclosure;
securing the enclosure; and
conducting a grow cycle that is facilitated by operating the control unit to control the lighting system, environmental control system and the irrigation system.

13. The method of claim 12, wherein the environmental control system includes an air filtration system.

14. The system of claim 13, wherein the air filtration system utilizes at least one three stage filter and is effective to regulate at least one of dust, mold, pollen, insects and chemical pollutants during the step of conducting the grow cycle.

15. The system of claim 13, wherein the environmental control system includes a humidity control system effective to regulate a humidity level in the enclosure.

16. The system of claim 11, further comprising a security monitoring subsystem that monitors at least one security condition related to the enclosure during the grow cycle.

17. The system of claim 11, wherein the step of conducting the grow cycle is automatically controlled by the control unit.

18. A growing system, comprising:
a readily relocatable enclosure having an entrance that is securable;
the enclosure having integrated with it a lighting system, an air filtration system, a humidity control system, an irrigation system and a security system;
a control unit external to the enclosure configured to control the lighting system, air filtration system, humidity control system, irrigation system and security system, whereby a grow cycle of a plurality of plants is facilitated within the enclosure.

19. The system of claim 18, wherein the control unit is configured to be remotely managed.

20. The system of claim 18, wherein the relocatable enclosure is configured so that it can be relocated without removal of the lighting system, air filtration system and irrigation system.
